(19) United States
(12) Patent Application Publication
(10) Pub. No.: US 2011/0242635 A1
(43) Pub. Date: Oct. 6, 2011

(54) Head-Mounted Display

(75) Inventor: Hidenori Oka, Tokai-shi (JP)

(73) Assignee: BROTHER KOGYO KABUSHIKI KAISHA, Nagoya-shi (JP)

(21) Appl. No.: 13/074,073

(22) Filed: Mar. 29, 2011

(30) Foreign Application Priority Data
Mar. 31, 2010 (JP) 2010-080027

(51) Int. Cl. G02B 26/10; G02B 5/18

(52) U.S. Cl. 359/207.7

(57) ABSTRACT

A head-mounted display includes a light source, a light scanner, an emitter, and a two-dimensional diffraction grating. The light source emits light having an intensity corresponding to an image signal. The light scanner performs two-dimensional scanning with the light emitted from the light source to produce image light. The head-mounted display emits the image light from the emitter. The two-dimensional diffraction grating is provided at a position near an intermediate image plane located in an optical path between the light source and the emitter. The diffraction grating enlarges an exit pupil of the head-mounted display. The diffraction grating has a multistep structure with groove depth changes of at least three discrete levels.

### CROSS-REFERENCE TO RELATED APPLICATION

This application claims priority from JP 2010-080027 filed on Mar. 31, 2010, the content of which is hereby incorporated by reference.

### BACKGROUND OF THE DISCLOSURE

1. Field of the Disclosure

A head-mounted display that causes image light to enter the pupil of an eye of a viewer and thus displays an image to the viewer is provided. More particularly, a technique of enlarging the exit pupil of the head-mounted display by utilizing a diffraction grating can be provided.

2. Description of the Related Art

Head-mounted displays (hereinafter abbreviated to HMD) are known as an apparatus that displays an image by directly projecting image light onto the retina of a viewer in such a manner as to scan the retina with the projected image light. Such an HMD in general includes the following: (a) a light source that emits light having an intensity corresponding to an image signal, (b) a light scanner that performs two-dimensional scanning with the light emitted from the light source to produce image light, and (c) an emitter from which the HMD emits the image light.

To enable the viewer to normally view an image displayed by the HMD, the exit pupil of the HMD needs to be at a position corresponding to the pupil of the viewer. However, while the viewer is viewing the displayed image, the eye of the viewer often moves to some extent, and naturally the pupil moves. Therefore, the exit pupil may be displaced relative to the pupil of the viewer. This particularly applies to a case where the exit pupil of the HMD is smaller than the pupil of the viewer.

To avoid such a situation, there is a known technique of enlarging the exit pupil of the HMD in which a diffraction grating is provided in an intermediate image plane located at a position in the optical path of the HMD halfway between the light source and the emitter. There is another known technique of further enlarging the exit pupil of the HMD in which a diffraction grating is provided at a position deviating from an intermediate image plane located at a position in the optical path of the HMD halfway between the light source and the emitter.

To two-dimensionally enlarge the exit pupil of the HMD, a two-dimensional diffraction grating may be utilized. A typical two-dimensional diffraction grating includes two one-dimensional binary diffraction gratings that are combined together such that the grating patterns thereof intersect. In such a typical configuration, a single two-dimensional diffraction grating has two diffraction-grating surfaces that are spaced apart from each other in the direction in which the light travels

Here, a case of an HMD including a two-dimensional diffraction grating provided as a combination of two one-dimensional binary diffraction gratings will be considered. Supposing that the two one-dimensional binary diffraction gratings are positioned with a gap of more than several tens of microns interposed therebetween in the direction in which the light travels, not all diffracted beams of different orders emitted from the one-dimensional binary diffraction gratings converge on a single point on the retina of the viewer, may produce a ghost image. Consequently, a problem can arise in that the quality of an image to be displayed is deteriorated.

### SUMMARY OF THE DISCLOSURE

Aspects of the present disclosure provide a head-mounted display forming an enlarged exit pupil by utilizing a diffraction grating.

According to an aspect of the present disclosure, a head-mounted display can include a light source, a light scanner, an emitter, and a two-dimensional diffraction grating. The light source emits light having an intensity corresponding to an image signal. The light scanner can perform two-dimensional scanning with the light emitted from the light source and thus produces image light. The head-mounted display emits the image light from the emitter. The two-dimensional diffraction grating can be provided at a position near an intermediate image plane located in an optical path between the light source and the emitter. The diffraction grating enlarges an exit pupil of the head-mounted display. The diffraction grating can have a multistep structure whose groove depth changes with at least three discrete levels.

### BRIEF DESCRIPTION OF THE DRAWINGS

For a more complete understanding of the disclosure, reference is now made to the following description taken in connection with the accompanying drawings.

FIG. 1 is a system diagram of a retinal scanning display according to a first illustrative embodiment;

FIG. 2 schematically shows the optical path of the retinal scanning display shown in FIG. 1;

FIG. 3 shows optical paths illustrating how an incoming beam diverges with an effect of diffraction by a multistep two-dimensional diffraction grating shown in FIGS. 1 and 2;

FIG. 4 is a perspective view of the two-dimensional diffraction grating shown in FIG. 3;

FIG. 5A is a sectional view of the two-dimensional diffraction grating shown in FIG. 3;

FIG. 5B is another sectional view of the two-dimensional diffraction grating shown in FIG. 3, taken along a line different from that for FIG. 5A;

FIG. 6 is a front view of a plurality of (x, y)th-order diffracted beams emitted in the form of a two-dimensional array from the two-dimensional diffraction grating shown in FIG. 3;

FIG. 7A is a front view of component beams two-dimensionally separated into diffracted beams of different orders by the two-dimensional diffraction grating shown in FIG. 3, and shows that the diffraction angles of the diffracted beams vary with the wavelengths of the diffracted beams;

FIG. 7B is a front view showing how the pupil of the viewer moves relative to the two-dimensional array of the diffracted beams of different orders;

FIG. 8 is a table summarizing standard deviations obtained from a simulation performed for determining values of the groove depth and projection width of the two-dimensional diffraction grating shown in FIG. 3;

FIG. 9A is a graph showing the result of a simulation performed for determining a value of the diffraction-grating pitch of a multistep two-dimensional diffraction grating included in a retinal scanning display according to a second illustrative embodiment;

FIG. 9B is a graph showing the result of a simulation performed for determining values of the groove depth and projection width of the two-dimensional diffraction grating; and

FIG. 10 is a table summarizing the calculated diffraction efficiencies for lower-order diffracted beams and higher-order diffracted beams of each of red, green, and blue beams, the calculated diffraction efficiencies being used in making the graph shown in FIG. 9B.

### DETAILED DESCRIPTION

Some illustrative embodiments of the present disclosure will now be described in detail with reference to the accompanying drawings. The configuration and so forth of the head-mounted display shown in the drawings is only exemplary and does not limit the scope of the present disclosure. For example, some elements of the configuration described below may be omitted or be substituted by other elements, or the configuration described below may include additional elements.

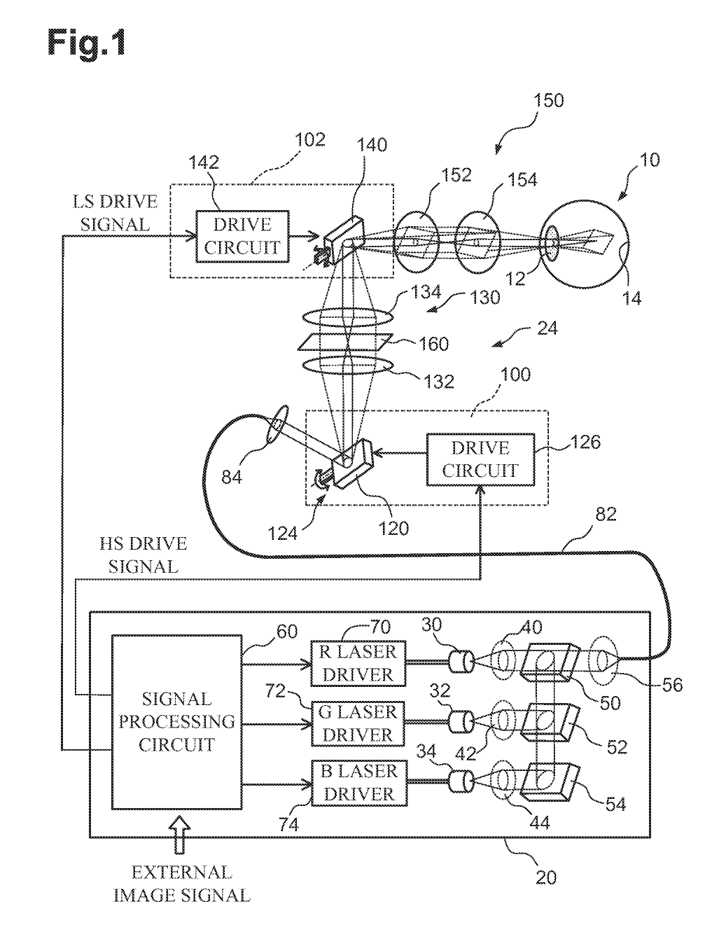

Referring to FIG. 1, according to a first illustrative embodiment of the present disclosure, a retinal scanning display (hereinafter abbreviated to RSD) performs scanning (e.g., two-dimensional scanning) with a laser beam produced as a flux of light having an intensity corresponding to an image signal. The RSD causes the scanning laser beam to enter a pupil 12 of an eye 10 of a viewer, thereby directly projecting and displaying an image on a retina 14 of the eye 10.

A light source unit 20 produces a laser beam of an arbitrary color by synthesizing three laser beams having three different colors (for example, the three primary colors of light, i.e., red (R), green (G), and blue (B)) into a single laser beam (a synthesized beam). The three colors have individually different wavelengths. The light source unit 20 includes a red (R) laser 30 that emits a red laser beam, a green (G) laser 32 that emits a green laser beam, and a blue (B) laser 34 that emits a blue laser beam. The red, green, and blue laser beams have wavelengths of 635 nm, 532 nm, and 460 nm, respectively.

The lasers 30, 32, and 34 in the first illustrative embodiment can be laser diodes. The laser beams emitted from the respective lasers 30, 32, and 34 can be collimated by collimating optical systems 40, 42, and 44, respectively. The laser beams strike dichroic mirrors 50, 52, and 54, respectively. The dichroic mirrors 50, 52, and 54 have wavelength dependencies. The laser beams can be selectively reflected by or transmitted through the dichroic mirrors 50, 52, and 54 in accordance with the wavelengths thereof, and thus can be synthesized into a single laser beam.

Subsequently, the synthesized laser beam can be collected by a coupling optical system 56 and enter a light transmitting medium such as an optical fiber 82. The laser beam that has entered the light transmitting medium, for example the optical fiber 82, can be transmitted through the optical fiber 82. The laser beam can be emitted from the distal end of the optical fiber 82, enter a collimating optical system 84 that collimates the laser beam, and enter a light scanner 24.

The above description concerns the optical aspect of the light source unit 20. The electrical aspect of the light source unit 20 will now be described. The light source unit 20 includes a signal processing circuit 60 that can be a microprocessor, a field-programmable gate array (FPGA), an application-specific integrated circuit (ASIC), or the like. The signal processing circuit 60 is configured to perform signal processing for driving the lasers 30, 32, and 34 and signal processing for scanning with the laser beam in accordance with an externally supplied signal, for example a picture signal.

To drive the lasers 30, 32, and 34, the signal processing circuit 60 supplies the lasers 30, 32, and 34 with drive signals (e.g., signals that represent the picture signal) necessary for realizing the required colors and intensities of the laser beams for individual pixels of an image to be projected on the retina 14. The drive signals can be supplied to the lasers 30, 32, and 34 through laser drivers 70, 72, and 74, respectively, in accordance with the externally supplied picture signal.

The light scanner 24 includes a high-speed (HS) scanner 100 (e.g., a main scanner) and a low-speed (LS) scanner 102 (e.g. a sub-scanner). The HS scanner 100 is an optical system that performs scanning with the laser beam at a relatively high speed (e.g., 30 kHz) and in a main scanning direction for each frame of an image to be displayed. The LS scanner 102 is an optical system that performs scanning with the laser beam at a relatively low speed (e.g., 60 Hz) and in a sub-scanning direction orthogonal to the main scanning direction for each frame of an image to be displayed. It will be appreciated that a relatively high speed and relatively low speed are based on the frame rate and the resolution of the image.

Specifically, the HS scanner 100 in the first illustrative embodiment includes an elastic member 124 provided with a mirror 120 with which mechanical deflection is realized. The mirror 120 is swung by the torsional resonance of the elastic member 124. The laser beam that has struck the mirror 120 is moved in the main scanning direction by the swinging of the mirror 120. The HS scanner 100 includes a drive circuit 126. The drive circuit 126 drives the mirror 120 in accordance with a high-speed (HS) drive signal supplied from the signal processing circuit 60.

As shown in FIG. 1, the laser beam moved by the HS scanner 100 is transmitted to the LS scanner 102 through a first relay optical system 130. The first relay optical system 130 can include a lens 132 as an upstream optical system and a lens 134 as a downstream optical system. It will be appreciated that the optical system is not limited to two elements such as lens 132 and lens 134, and that other optical elements may be used alone or in combination with any one of lens 132 and lens 134.

The LS scanner 102 can include a galvanometer mirror 140 as a swingable mirror with which mechanical deflection is realized. The galvanometer mirror 140 is forcibly and electromagnetically driven in a non-resonant mode. The laser beam that strikes the galvanometer mirror 140 is moved in the sub-scanning direction. The laser beam moved by and emitted from the HS scanner 100 is collected on the galvanometer mirror 140 through the first relay optical system 130. The LS scanner 102 also includes a drive circuit 142. The drive circuit 142 drives the galvanometer mirror 140 in accordance with a low-speed (LS) drive signal (or a synchronization signal) supplied from the signal processing circuit 60.

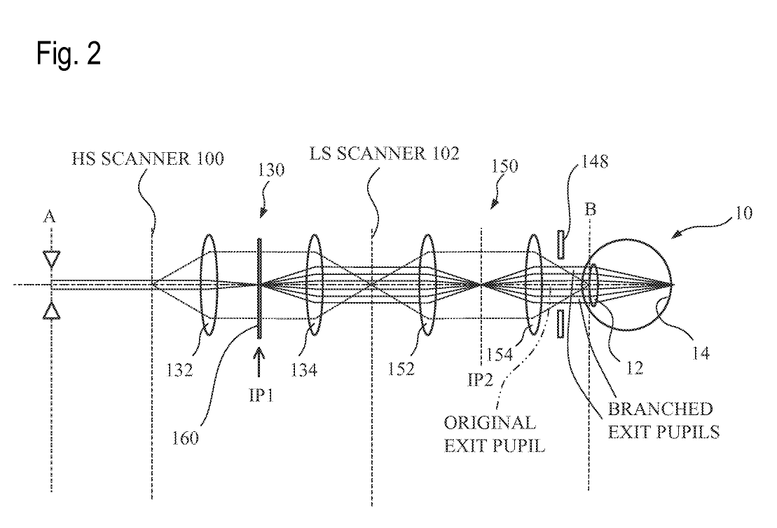

Thus, the HS scanner 100 and the LS scanner 102 in cooperation perform two-dimensional scanning with the laser beam. Image light produced by scanning with the laser beam can be transmitted through a second relay optical system 150 and can be emitted from an emitter 148 (see FIG. 2) provided as a translucent portion of the housing of the RSD. The image light emitted from the emitter 148 is applied to the eye 10 of the viewer. The second relay optical system 150 can include a lens 152 as an upstream optical system and a lens 154 as a downstream optical system.

FIG. 2 schematically shows the optical path of the RSD shown in FIG. 1. There are two intermediate image planes IP1 and IP2 in the optical path.

In a case where the light scanner 24 includes a plurality of optical components, the “intermediate image plane” can be defined in a space between those optical components. Furthermore, in a case where the emitter 148 includes a plurality of optical components, the “intermediate image plane” can be defined in a space between those optical components. The position “near” the intermediate image plane includes a position in the intermediate image plane and positions in the optical path within a specific distance from the intermediate image plane on both upstream and downstream sides. Within the specific distance, the exit pupil of the head-mounted display is substantially enlarged by providing a two-dimensional diffraction grating.

Specifically, the first relay optical system 130 resides between the HS scanner 100, functioning as a main scanning system, and the LS scanner 102, functioning as a sub-scanning system. In the first relay optical system 130, the lens 132 and the lens 134 are arranged coaxially. The intermediate image plane IP1 is located between the lenses 132 and 134.

The second relay optical system 150 resides between the LS scanner 102 and the eye 10. In the second relay optical system 150, the lens 152 and the lens 154 can be arranged coaxially. The intermediate image plane IP2 is located between the lenses 152 and 154.

The intermediate image planes IP1 and IP2 are located between the image plane on the retina 14 (i.e., the final image plane) and the light source (i.e., the lasers 30, 32, and 34). Focusing on this fact, the term “intermediate image plane” is used in this specification so as to descriptively differentiate the image planes IP1 and IP2 from the “final image plane”. That is, the term “intermediate image plane” does not necessarily refer to an image plane located at the exact midpoint between the emitter 148 and the light source (i.e., the lasers 30, 32, and 34).

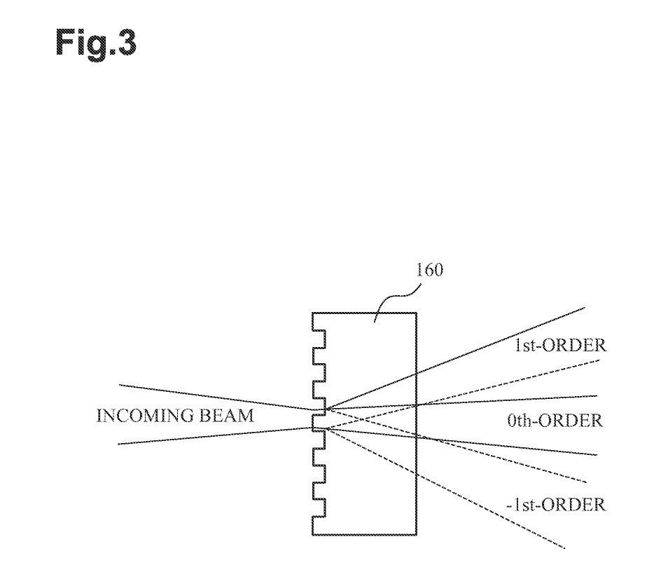

In the first illustrative embodiment, as shown in FIGS. 1 and 2, a multistep two-dimensional diffraction grating 160 can be provided in the first relay optical system 130. The “two-dimensional diffraction grating” may be formed integrally with a component included in the light scanner 24 or the emitter 148, or may be provided as an independent body and be attached to or be provided separately from a component included in the light scanner 24 or the emitter 148. Specifically, the two-dimensional diffraction grating 160 can be provided in the intermediate image plane IP1 that is, between the lens 132 and the lens 134. More specifically, referring to FIG. 3, the two-dimensional diffraction grating 160 can be provided such that the laser beam emitted from the lens 132 of the first relay optical system 130 and perpendicularly entering the two-dimensional diffraction grating 160 is incident on the two-dimensional diffraction grating 160 at the beam waist thereof. That is, the two-dimensional diffraction grating 160 can be provided at the converging point of the laser beam.

According to the first illustrative embodiment, as shown in FIGS. 2 and 3, the beam entering the two-dimensional diffraction grating 160 diverges with an effect of diffraction by the two-dimensional diffraction grating 160. That is, the exit pupil of the RSD can be enlarged. Therefore, even if the center of the pupil 12 of the viewer is displaced relative to the center of the exit pupil to some extent, the possibility that the entirety of the pupil 12 is displaced relative to the exit pupil can be reduced. Thus, the image can be displayed stably.

While the two-dimensional diffraction grating 160 can be provided in the intermediate image plane IP1 in the first illustrative embodiment, the two-dimensional diffraction grating 160 may alternatively be provided at a position between the lens 132 and the lens 134 that is not in the intermediate image plane IP1 in the first relay optical system 130. While the two-dimensional diffraction grating 160 can be transmissive in the first illustrative embodiment, the two-dimensional diffraction grating 160 may alternatively be reflective. While the two-dimensional diffraction grating 160 can be provided in the intermediate image plane IP1 in the first illustrative embodiment, the two-dimensional diffraction grating 160 may alternatively be provided in the second relay optical system 150 between the lens 152 and the lens 154, and may or may not be provided in the intermediate image plane IP2. In the case where the two-dimensional diffraction grating 160 is provided in the intermediate image plane IP1, an enlarged exit pupil can be formed in the LS scanner 102. Therefore, the LS scanner 102 should be large enough to include a mirror larger than the enlarged exit pupil. In contrast, in the case where the two-dimensional diffraction grating 160 can be provided in the second optical relay system 150 between lens 152 and lens 154, but not in the intermediate image plane IP2, such a size requirement is not imposed on the LS scanner 102, and, for example, a small scanner such as a microelectromechanical-system (MEMS) scanner can be employed as the LS scanner 102.

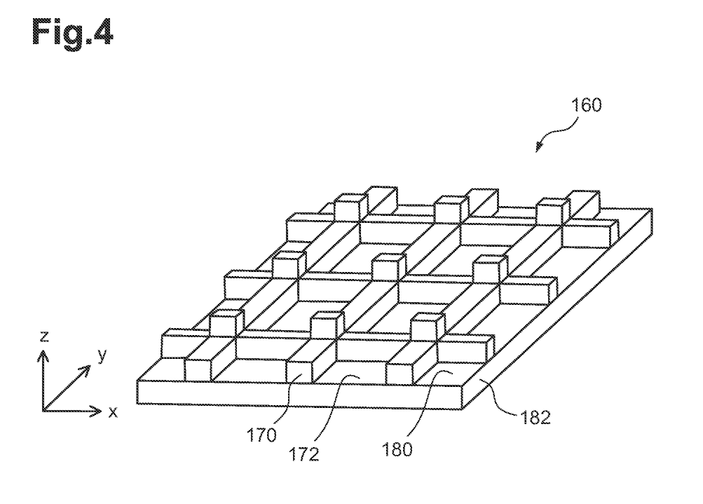

Referring to FIG. 4, the two-dimensional diffraction grating 160 has a flat surface and a plurality of grooves (or ridges) extending two-dimensionally on the flat surface. The grooves (or ridges) can be arranged in such a manner as to be partially combined one on top of another in the depth (height) direction thereof. Basically, the grooves can have rectangular sections. Alternatively, the grooves (or ridges) may be formed in a sawtooth shape or a sinusoidal shape, for example. The grooves can have a multistep structure in which the depth thereof changes stepwise in the longitudinal direction thereof with three or more levels (in the first illustrative embodiment, three levels).

Specifically, the two-dimensional diffraction grating 160 has projections 170 and grooves 172 (also considered as “depressions”) that can be arranged alternately and periodically at a specific diffraction-grating pitch P both in the lateral direction (the x direction) and in the longitudinal direction (the y direction). The two-dimensional diffraction grating 160 can be a substrate 182 patterned three-dimensionally with a reference surface 180. In this example, when the two-dimensional diffraction grating 160 is seen in its entirety, the two-dimensional diffraction grating 160 has a structure (periodic structure) whose groove depth (z-direction dimension) changes with three or more levels.

In the first illustrative embodiment, it can be considered that the reference surface 180 is a unique reference surface of the two-dimensional diffraction grating 160, and the reference surface 180 is a unique diffraction-grating surface of the two-dimensional diffraction grating 160. In the first illustrative embodiment, the two-dimensional diffraction grating 160 can be positioned in the RSD such that the diffraction-grating surface thereof coincides with the intermediate image plane IP1.

In the first illustrative embodiment, the periodic structure of the two-dimensional diffraction grating 160 can be considered that, in a specific section, high projections 170 and low projections 170 (the low projections 170 appear to be grooves 172 when seen from the high projections 170) are alternately arranged, or deep grooves 172 and shallow grooves 172 (the shallow grooves 172 appear to be projections 170 when seen from the deep grooves 172) are alternately arranged. This is because the projections 170 and the grooves 172 are geometrically complementary to each other and are interchangeable therebetween.

Hence, in describing the periodic structure of the two-dimensional diffraction grating 160, the projection height and the groove depth are complementary to each other and are interchangeable therebetween. In the field concerned, since it is more general to use the term “groove depth” than to use the term “projection height”, the term “groove depth” is used in this specification. For the convenience of description, the periodic structure of the two-dimensional diffraction grating 160 can be regarded as a structure in which high projections 170 and low projections 170 are arranged alternately in a specific section, and a term “groove depth d” can be used as the vertical length (projection height) from the reference surface 180, whether the projections 170 are high or low. In the first illustrative embodiment, the groove depth d can be any of the following three values: zero (0), the maximum depth D, and half the maximum depth D/2.

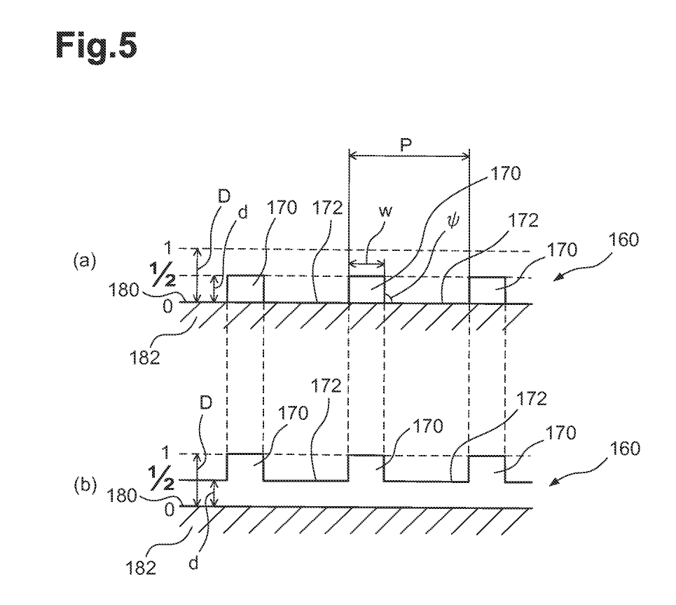

More specifically, referring to FIGS. 5A and 5B, the two-dimensional diffraction grating 160 can have two kinds of profiles. In a first illustrative profile shown in FIG. 5A, projections 170 corresponding to a groove depth d equal to half the maximum depth D/2 and grooves 172 corresponding to a groove depth d equal to 0 are provided alternately. Meanwhile, in a second illustrative profile shown in FIG. 5B, projections 170 corresponding to a groove depth d equal to the maximum depth D and grooves 172 corresponding to a groove depth d equal to half the maximum depth D/2 are provided alternately. Hence, in the first illustrative embodiment, only when the two-dimensional diffraction grating 160 is seen in its entirety, can it be recognized that the two-dimensional diffraction grating 160 has a multistep structure with three discrete levels of groove depth d. The two-dimensional diffraction grating 160 may have another multistep structure having three or more discrete levels of groove depth d when seen in the x or y direction.

The reference characters shown in FIGS. 5A and 5B are denoted as follows:

p: the diffraction-grating pitch (for example, 10.5 μm) at which the projections 170 or the grooves 172 are provided periodically.

w: the projection width (for example, 2.85 μm), i.e., the width of each projection 170 at its top.

D: the maximum depth, i.e., the maximum value for the groove depth d.

Ψ: the cone angle formed by the side face of each projection 170 (the angle formed between the side face and the reference surface 180; for example, 90 degrees).

If the diffraction-grating pitch p and the projection width w are determined, the width of the grooves 172 (hereinafter referred to as the groove width) can be determined. Furthermore, the duty ratio γ, i.e., the ratio of the groove width to the period of the grooves 172, can be determined. Hence, determining the diffraction-grating pitch p and then the projection width w can determine the duty ratio γ.

The values for the above reference characters are design parameters that determine the configuration of the two-dimensional diffraction grating 160. Among these design parameters, the diffraction-grating pitch p is in can have an impact on the magnitude of diffraction angle of a set of all diffracted beams (the extent to which diffracted beams diverge). Meanwhile, the groove depth d and the duty ratio γ also can have an impact on the diffraction efficiency for each of the diffracted beams of different orders having different wavelengths.

The synthesized beam entering the two-dimensional diffraction grating 160 can be separated into diffracted beams of different orders traveling in different directions, as shown in FIG. 3, for each of component beams, specifically, red, green, and blue beams. Thus, the diffracted beams are emitted from the two-dimensional diffraction grating 160. The diffracted beams of different orders include at least 0th-order, +1st-order, and −1st-order diffracted beams, for example.

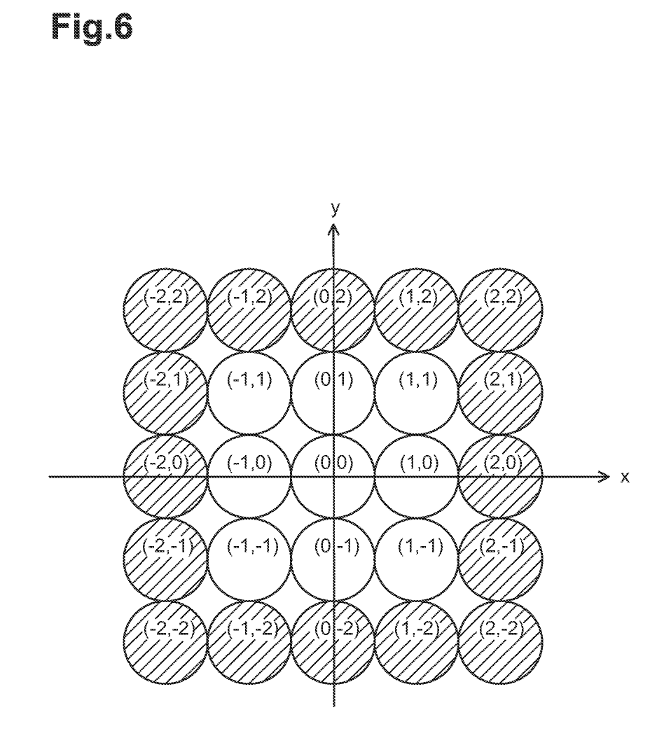

The two-dimensional diffraction grating 160 can enlarge the exit pupil by utilizing the diffracted beams of different orders. Referring to FIG. 6, diffracted beams of different orders at the exit pupil are aligned two-dimensionally in the x and y directions. The diffracted beams of different orders are each expressed as an (x, y)th-order diffracted beam, where x denotes an order of diffraction in the x direction, and y denotes an order of diffraction in the y direction. FIG. 6 shows a two-dimensional array of a plurality of (x, y)th-order diffracted beams. In FIG. 6, the (x, y)th-order diffracted beams, which are instantaneous laser beams, are shown in circular sections. The (x, y)th-order diffracted beams each have a diameter of 1 mm, for example.

In the first illustrative embodiment, the ratio of the power (W) of each of the (x, y)th-order diffracted beams to the power (W) of the beam applied over the entirety of the two-dimensional diffraction grating 160 is defined as the diffraction efficiency e(x, y). The diffraction efficiency e(x, y) is defined for each of the component beams. Let characters a and b denote arbitrary orders. Then, the diffraction efficiency e(x, y) is the same for diffracted beams of the (a, b)th order, the (−a, b)th order, the (a, −b)th order, and the (−a, −b)th order. The diffraction efficiency e(x, y) is also the same for diffracted beams of the (a, b)th order and the (b, a)th order. This is because the two-dimensional diffraction grating 160 is patterned in such a manner as to form geometric mirror images with respect to both of the x and y axes.

The diffraction efficiency e(x, y) for each of the (x, y)th-order diffracted beams can be varied by tuning the projection width w and groove depth d of the two-dimensional diffraction grating 160. However, the diffraction efficiencies e(x, y) for a plurality of (x, y)th-order diffracted beams having different wavelengths are not exactly the same. Therefore, depending on the position in the exit pupil, enlarging the exit pupil by utilizing diffraction may change the brightness balance among diffracted beams having different wavelengths but passing through substantially the same position in the exit pupil and synthesized together. Consequently, the color balance of the displayed image may change.

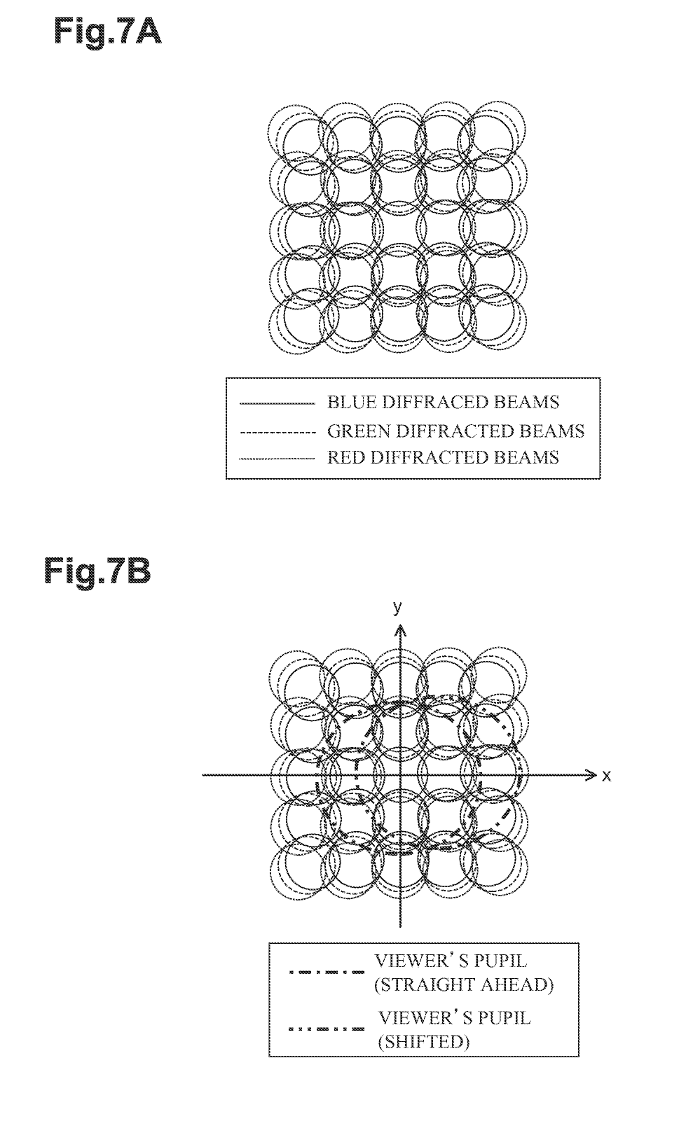

Referring to FIG. 7A, each of the component beams entering the two-dimensional diffraction grating 160 is two-dimensionally separated into a plurality of (x, y)th-order diffracted beams. The diffraction angles of the diffracted beams vary with the wavelengths of the diffracted beams. Specifically, the longer the wavelengths of the component beams and the higher the orders of diffraction, the larger the diffraction angles of the diffracted beams and the larger the displacement of each diffracted beam relative to another diffracted beam having a different wavelength.

FIG. 7B shows how the pupil 12 of the viewer moves relative to the two-dimensional array of such (x, y)th-order diffracted beams. The pupil 12 has a diameter of 3 mm, for example. When the pupil 12 faces straight ahead with respect to the face of the viewer, that is, when the center of the pupil 12 corresponds to the origin of the array shown in FIG. 7B, a (0, 0)th-order diffracted beam, a (1, 0)th-order diffracted beam and equivalents thereof, and a (1, 1)th-order diffracted beam and equivalents thereof are within an area corresponding to the pupil 12 for each of the component beams. In FIG. 6, among the plurality of (x, y)th-order diffracted beams, those within the area corresponding to the pupil 12 are shown as empty circles, and the others are shown as hatched circles.

In the first illustrative embodiment, the projection width w and groove depth d of the two-dimensional diffraction grating 160 can be tuned such that the diffraction efficiencies e(x, y) for the (x, y)th-order diffracted beams within the area corresponding to the pupil 12 are as close to one another as possible in the state where the pupil 12 faces straight ahead.

In the first illustrative embodiment, the design parameters that determine the configuration of the two-dimensional diffraction grating 160 include the diffraction-grating pitch p, the cone angle Ψ, the projection width w, and the maximum depth D. As an example, the diffraction-grating pitch p was set to 10.5 μm, and the cone angle Ψ was set to 90 degrees. It will be appreciated that the diffraction-grating pitch can be set to other appropriate values above or below 10.5 μm based on pupil size, wavelength of light sources, beam width, etc. An illustrative method of setting the diffraction-grating pitch p will be described separately below in a second embodiment.

For example, the two-dimensional diffraction grating 160 can be manufactured by dry etching. In such a case, unlike in a case of manufacturing by wet etching, there is no need to consider the orientations of crystal faces that affect the shape of the finished product. Furthermore, unlike in a case of manufacturing by molding, there is no need to consider the slope for removal of the mold. Hence, it is possible to manufacture the two-dimensional diffraction grating 160 with the cone angle Ψ of 90 degrees.

The design parameters yet to be determined in the example are the projection width w and the maximum depth D, which impact the tuning of the diffraction efficiency of the two-dimensional diffraction grating 160. In the first illustrative embodiment, the foregoing design parameters can be set such that the standard deviation of the diffraction efficiencies e(x, y) for the plurality of (x, y)th-order diffracted beams that are within the area corresponding to the pupil 12 can be minimized for each of the component beams. The (x, y)th-order diffracted beams that are within the area corresponding to the pupil 12 are the (0, 0)th-order diffracted beam and all of the (1, 0)th-order and (1, 1)-th order diffracted beams (including the diffracted beams of other orders that are the equivalents thereof, which also applies to the description hereinafter). Such a setting of the design parameters is an illustrative method of setting the design parameters such that the extent of distribution of all diffraction efficiencies e(x, y) can be minimized.

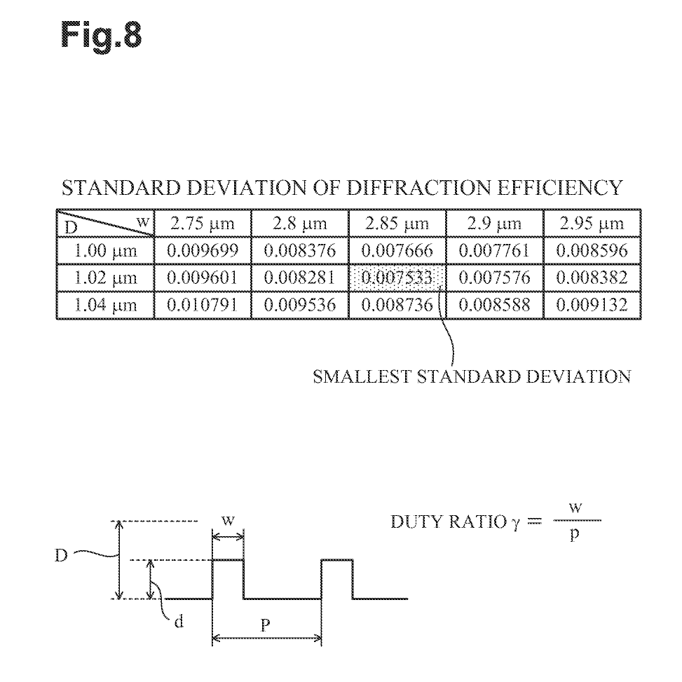

FIG. 8, for a particular diffraction-pitch, shows three candidate values of 1.00 μm, 1.02 μm, and 1.04 μm selected for the maximum depth D and five candidate values of 2.75 μm, 2.8 μm, 2.85 μm, 2.9 μm, and 2.95 μm selected for the projection width w, with which a total of fifteen candidate combinations are obtained.

For each of the candidate combinations, the diffraction efficiency e(0, 0) for the (0, 0)th-order diffracted beam, the diffraction efficiencies e(1, 0) for the (1, 0)-th order diffracted beams, and the diffraction efficiencies e(1, 1) for the (1, 1)th-order diffracted beams were calculated on the basis of a commonly used diffraction-grating expression for each of the wavelengths of the three component beams entering the two-dimensional diffraction grating 160. For each of the candidate combinations, a total of nine calculated values of diffraction efficiency e are obtained.

Furthermore, the standard deviations of the nine diffraction efficiencies e were calculated for each of the fifteen candidate combinations. The results of the calculations are shown in FIG. 8. Among the fifteen candidate combinations, the combination of the maximum depth D of 1.02 μm and the projection width w of 2.85 μm showed the smallest standard deviation and was taken as the design parameters.

On the basis of this result, in the first illustrative embodiment, the two-dimensional diffraction grating 160 is designed to have a maximum depth D of 1.02 μm and a projection width w of 2.85 μm. Hence, according to the first illustrative embodiment, even if the pupil 12 is displaced relative to the exit pupil to some extent during viewing of an image through the RSD, changes in the color balance of the displayed image due to the displacement can be suppressed.

In the first illustrative embodiment, the two-dimensional diffraction grating 160 is designed such that the extent of distribution of all diffraction efficiencies e(x, y) for the (0, 0)th-order, (1, 0)th-order, and (1, 1)th-order diffracted beams can be minimized for each of the three component beams. Alternatively, the two-dimensional diffraction grating 160 may be designed such that the diffraction efficiencies e(x, y) are equal to a value or within a range that can be preset in such a manner as to suppress changes in the color balance of the displayed image due to the displacement of the pupil 12.

As apparent from the above description, in the first illustrative embodiment, the two-dimensional diffraction grating 160 has a unique diffraction-grating surface and is positioned in the RSD such that the unique diffraction-grating surface coincides with the intermediate image plane IP1 (or IP2). Hence, according to the first illustrative embodiment, all diffracted beams emitted from the two-dimensional diffraction grating 160 converge on one point on the retina 14 and form an image, unlike in the case where the two-dimensional diffraction grating 160 includes two one-dimensional binary diffraction gratings that are combined together with a specific gap interposed therebetween. Thus, the exit pupil can be enlarged by diffraction, and the occurrence of a ghost image can be prevented. Consequently, the deterioration in the quality of the displayed image can be prevented.

In the case where the two-dimensional diffraction grating 160 is provided as a combination of two one-dimensional binary diffraction gratings, the one-dimensional binary diffraction gratings may be positioned as close to each other as possible so that the occurrence of a ghost image can be suppressed. However, if such a configuration is simply employed, another problem arises in that interference fringes may appear frequently.

To suppress the appearance of interference fringes, the surfaces of the one-dimensional binary diffraction gratings may be antireflection (AR)-coated. However, if the AR coating is simply provided, other problems arise in that dust particles generated during AR coating may adhere to the surfaces of the diffraction gratings and such dust particles may be visible to the viewer as black spots in the displayed image, and that missed spots in AR coating may be visible to the viewer as bright spots in the displayed image. In either case, if AR coating is employed, an operation step for AR coating is added and the operation needs to be performed very carefully. Therefore, the time required for manufacturing the two-dimensional diffraction grating 160 increases, resulting in a reduction in the product yield rate.

In contrast, according to the first illustrative embodiment, the ghost image due to the provision of the two-dimensional diffraction grating 160 in the RSD does not occur, and the operation step for AR coating is not necessary.

An alternative technique may be employed in which the two-dimensional diffraction grating 160 is a lens array. In such a case, however, a problem arises in that it is technically difficult to adjust the balance of diffraction efficiency of the lens array among different wavelengths of light entering the lens array.

In contrast, according to the first illustrative embodiment, the two-dimensional diffraction grating 160 has a multistep structure, and design parameters including not only the duty ratio γ but also the groove depth d being defined for tuning the diffraction efficiency of the two-dimensional diffraction grating 160. Therefore, according to the first illustrative embodiment, the degree of flexibility in tuning the diffraction efficiency of the two-dimensional diffraction grating 160 is higher than in the case where a combination of binary diffraction gratings is employed. Thus, according to the first illustrative embodiment, the balance of the diffraction efficiency of the two-dimensional diffraction grating 160 can be readily adjusted among different wavelengths than in the case where a combination of binary diffraction gratings is employed.

Furthermore, according to the first illustrative embodiment, the diffraction efficiencies e(x, y) for the three component beams are as close to one another as possible within the area corresponding to the pupil 12. In other words, the projection width w (reflected in the duty ratio γ) and the maximum depth D are set such that the brightness, i.e., the intensities, of the diffracted beams having the three colors and being within the exit pupil are as uniform as possible. Therefore, according to the first illustrative embodiment, even if the pupil 12 is displaced relative to the exit pupil to some extent during viewing of an image through the RSD, unexpected changes in the colors of the displayed image due to the displacement of the pupil 12 can be suppressed.

An RSD according to a second illustrative embodiment will now be described. The second illustrative embodiment differs from the first illustrative embodiment in the method of setting the design parameters of the two-dimensional diffraction grating 160 and in the values of the design parameters. The other details are common to the first and second illustrative embodiments. Therefore, only the different features will be described in detail, and redundant description of the common details is omitted.

The outline is that, as described above, by tuning the diffraction-grating pitch p of the two-dimensional diffraction grating 160, the diffraction angle can be enlarged, and thus the exit pupil of the RSD can be enlarged. However, if the exit pupil is enlarged excessively, the brightness of the synthesized beam applied to the retina 14 through the pupil 12 can be reduced, and the displayed image can be darkened. That is, there is a trade-off relationship between the diameter of the exit pupil and the brightness of the displayed image. Hence, the tuning of the diffraction-grating pitch p impacts both the enlargement of the exit pupil and the setting of the brightness, or the intensity, of the synthesized beam applied to the retina 14 through the pupil 12.

There is another trade-off relationship between the diameter of the exit pupil and the color balance of the displayed image. As the exit pupil is made larger, diffracted beams of higher orders are utilized at positions farther from the center of the exit pupil. The higher the order of the diffracted beam and the longer the wavelength of the diffracted beam, the larger the diffraction angle. Therefore, the separation of red diffracted beams from green and blue diffracted beams becomes more noticeable. That is, as the exit pupil is made larger, the tendency that red diffracted beams are viewed separately from the other-colored diffracted beams without being synthesized therewith becomes more noticeable particularly for diffracted beams of higher orders, and consequently the color balance of the displayed image is worsened (the difference in brightness among the three colors increases). To avoid such a situation, if the diffraction efficiencies for red lower-order diffracted beams are increased, the diffraction efficiencies for red higher-order diffracted beams can be reduced. Thus, changes in the color balance of the displayed image due to the displacement of the pupil 12 can be suppressed.

In addition, the diffraction efficiencies for red lower-order diffracted beams can be increased and the diffraction efficiencies for red higher-order diffracted beams can be reduced by tuning the projection width w and groove depth d of the two-dimensional diffraction grating 160.

A method of tuning the diffraction-grating pitch p of the two-dimensional diffraction grating 160 will now be described in detail. In the second illustrative embodiment, a reference brightness is set in advance. The reference brightness is the brightness of the light entering the pupil 12 from the RSD when the displacement of the center of the pupil 12 relative to a reference position, i.e., a straight-ahead position, due to the rotation of the eye 10 during viewing of an image through the RSD is zero (the displacement is hereinafter referred to as the “displacement of the pupil center”). The “light entering the pupil 12” is a synthesized beam produced by synthesizing the three component beams, i.e., red, green, and blue beams. The diameter of the pupil 12 is assumed to be 3 mm. Hence, the “brightness of the light entering the pupil 12” means the brightness of a portion of the synthesized beam emitted from the RSD that is applied to the retina 14 through the pupil 12 having a diameter of 3 mm.

In the second illustrative embodiment, the diffraction-grating pitch p of the two-dimensional diffraction grating 160 is set in advance such that, when the displacement of the pupil center is within a predetermined allowable range, the ratio of the brightness of the synthesized beam emitted from the RSD, entering the pupil 12, and applied to the retina 14 to the reference brightness is not below a preset value. Here, the “ratio” refers to the brightness of the synthesized beam entering the pupil 12 and applied to the retina 14 relative to the reference brightness.

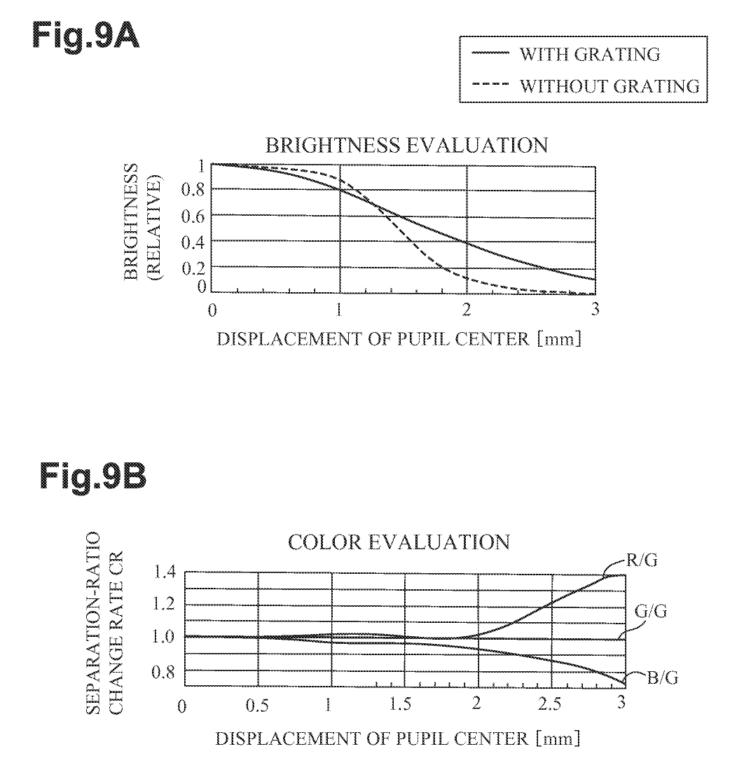

Referring to the graph shown in FIG. 9A, the solid curve represents a case where the diffraction-grating pitch p is 10.5 μm, the cone angle Ψ is 90 degrees, and the focal length of the lens 134 is 17 mm. As apparent from the solid curve in FIG. 9A, if the diffraction-grating pitch p is set to, for example, 10.5 μm when the cone angle Ψ is 90 degrees and the focal length of the lens 134 is 17 mm, the brightness (relative value) of the synthesized beam applied to the retina 14 can be prevented from becoming below about 0.4, unless the displacement of the pupil center exceeds 2 mm. That is, unless the displacement of the pupil center exceeds 2 mm, the brightness of the synthesized beam applied to the retina 14 can be prevented from being reduced by more than 60% relative to the reference brightness. Hence, in the case where the diffraction-grating pitch p is set to 10.5 μm, even if the pupil 12 is displaced relative to the exit pupil to some extent during viewing of an image through the RSD, unexpected changes in the brightness of the displayed image due to the displacement can be suppressed. For reference, the broken curve in FIG. 9A represents the result of a simulation using a comparative example in which the two-dimensional diffraction grating 160 is removed from the RSD. According to the comparative example, when the displacement of the pupil center exceeds about 1.5 mm, the brightness of the synthesized beam applied to the retina 14 can be reduced by more than 60% relative to the reference brightness.

A method of tuning the projection width w and groove depth d of the two-dimensional diffraction grating 160 will now be described in detail. In the second illustrative embodiment, each of the component beams included in the synthesized beam entering the two-dimensional diffraction grating 160 is converted by the two-dimensional diffraction grating 160 into diffracted beams of different orders that are separate from one another, and the diffracted beams are thus emitted. The ratio of the power of the n-th-order diffracted beam to the power of each of the component beams included in the synthesized beam entering the two-dimensional diffraction grating 160 is defined as the n-th-order-beam diffraction efficiency.

In the second illustrative embodiment, the projection width w and the maximum depth D for the groove depth d are set such that the longer the wavelengths of the component beams included in the synthesized beam entering the two-dimensional diffraction grating 160, the higher the lower-order-beam diffraction efficiencies of the two-dimensional diffraction grating 160 including the 0th-order-beam diffraction efficiency.

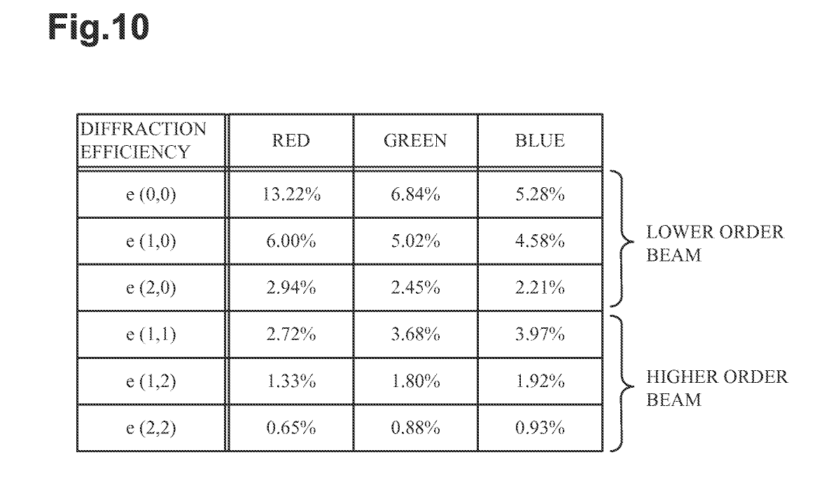

FIG. 10 summarizes calculated diffraction efficiencies e(x, y) for the red, green, and blue beams applied to the retina 14 through the pupil 12 when the center of the pupil 12 is displaced relative to the reference position by 2 mm in a case where the diffraction-grating pitch p is 10.5 μm, the maximum depth D is 0.88 μm, and the projection width w is 2.60 μm. Specifically, FIG. 10 summarizes the calculated diffraction efficiencies e(x, y) for the (0, 0)th-order, (1, 0)th-order, (1, 1)th-order, (2, 0)th-order, (1, 2)th-order, and (2, 2)th-order diffracted beams, shown in FIG. 7B, among a plurality of (x, y)th-order diffracted beams.

As summarized in FIG. 10, regarding the red beam whose wavelength is longer than those of the other-colored beams, i.e., the green and blue beams, the diffraction efficiency e(0, 0) for the (0, 0)th-order diffracted beam, which is one of lower-order diffracted beams, is 13.22%; and the diffraction efficiency e(2, 2) for the (2, 2)th-order diffracted beam, which is one of higher-order diffracted beams, is 0.65%. As can be seen, the diffraction efficiency e is higher for lower-order diffracted beams than for higher-order diffracted beams. As summarized in FIG. 10, the extent of such a difference is larger for the red beam than for the other-colored beams, i.e., the green and blue beams, whose wavelengths are shorter than that of the red beam.

In the second illustrative embodiment, the values of the maximum depth D and the projection width w can be set to 0.88 μm and 2.60 μm, respectively. Hence, it is considered that the maximum depth D and the projection width w (and the duty ratio γ) are set such that the longer the wavelengths of the component beams included in the synthesized beam entering the two-dimensional diffraction grating 160, the higher the lower-order-beam diffraction efficiencies of the two-dimensional diffraction grating 160 including the 0th-order-beam diffraction efficiency.

On the basis of the calculated diffraction efficiencies summarized in FIG. 10, the graph in FIG. 9B shows how the color balance of the displayed image changes as the displacement of the pupil center increases. When a single beam (synthesized beam) entering the two-dimensional diffraction grating 160 is separated by the two-dimensional diffraction grating 160 into diffracted beams (component beams) having three colors, the power of the synthesized beam is divided into powers of the respective diffracted beams (component beams). The vertical axis of the graph shown in FIG. 9B represents the separation-ratio change rate CR, i.e., the rate of relative change in the brightness ratio, for each of the component beams, of some of the beams emitted from the two-dimensional diffraction grating 160 that are applied to the retina 14 through the pupil 12.

The separation-ratio change rate CR is obtained for each of the red, green, and blue diffracted beams. In the graph shown in FIG. 9B, the separation-ratio change rate CR of the red diffracted beam is denoted by “R/G”, the separation-ratio change rate CR of the green diffracted beam is denoted by “G/G”, and the separation-ratio change rate CR of the blue diffracted beam is denoted by “B/G”.

The brightness ratio of each component beam entering the pupil 12 from the RSD when the displacement of the pupil center is 0 is defined as the “reference separation ratio”. Let the “reference separation ratio” be defined as a relative value of a reference diffracted beam (in the second illustrative embodiment, the green diffracted beam having a medium wavelength). Then, the “reference separation ratio” of the red diffracted beam is a value obtained by dividing a brightness KR0 of the red diffracted beam entering the pupil 12 when the displacement of the pupil center is 0 by a brightness KG0 of the green diffracted beam entering the pupil 12 when the displacement of the pupil center is 0 (i.e., a value expressed as KR0/KG0).

The “separation-ratio change rate CR” of the diffracted beam of each color is the rate of change with respect to the “reference separation ratio” obtained when the displacement of the pupil center is 0. For example, divide a brightness KRi of the red diffracted beam entering the pupil 12 when the displacement of the pupil center is an arbitrary value i by a brightness KGi of the green diffracted beam entering the pupil 12 when the displacement of the pupil center is the arbitrary value i (the division is expressed as KRi/KGi). Furthermore, divide the result of the foregoing division by the “reference separation ratio”, that is, KR0/KG0. Thus, the separation-ratio change rate CR (expressed as (KRi/KGi)/(KR0/KG0)) is obtained.

Thus, to calculate the separation-ratio change rate CR of the red diffracted beam, the following are used: (a) a brightness KRi of the red diffracted beam when the displacement of the pupil center is an arbitrary value i, (b) a brightness KR0 of the red diffracted beam when the displacement of the pupil center is 0, (c) a brightness KGi of the green diffracted beam when the displacement of the pupil center is the arbitrary value i, and (d) a brightness KG0 of the green diffracted beam when the displacement of the pupil center is 0.

The brightness KRi is calculated as the sum of the diffraction efficiencies e for the red diffracted beams, among a plurality of (x, y)th-order diffracted beams, that are applied to the retina 14 through the pupil 12 when the displacement of the pupil center is an arbitrary value i. The brightness KR0 is calculated as the sum of the diffraction efficiencies e for the red diffracted beams, among a plurality of (x, y)th-order diffracted beams, that are applied to the retina 14 through the pupil 12 when the displacement of the pupil center is 0.

The brightness KGi is calculated as the sum of the diffraction efficiencies e for the green diffracted beams, among a plurality of (x, y)th-order diffracted beams, that are applied to the retina 14 through the pupil 12 when the displacement of the pupil center is an arbitrary value i. The brightness KG0 is calculated as the sum of the diffraction efficiencies e for the green diffracted beams, among a plurality of (x, y)th-order diffracted beams, that are applied to the retina 14 through the pupil 12 when the displacement of the pupil center is 0.

The above calculation procedure also applies to the separation-ratio change rate CR of the blue diffracted beam. Needless to calculate, the separation-ratio change rate CR of the green diffracted beam, to which the calculation procedure also applies, is 1 over the entire range of displacement of the pupil center according to the definition thereof.

In FIG. 9B, as described above, the diffraction-grating pitch p is 10.5 μm, which is a value for satisfying the requirement that the rate of reduction in the brightness of the displayed image when the displacement of the pupil center is 2 mm be 60% or lower. In addition, the maximum depth D and the projection width w are 0.88 μm and 2.60 μm, respectively, which are values for suppressing changes in the color balance of the displayed image due to the displacement of the pupil 12. The graph in FIG. 9B shows how the separation-ratio change rate R/G of the red diffracted beam, the separation-ratio change rate G/G of the green diffracted beam, and the separation-ratio change rate B/G of the blue diffracted beam change with the displacement of the pupil center in the foregoing case. As shown in the graph, as long as the displacement of the pupil center is within 2 mm, changes in the separation-ratio change rate R/G of the red diffracted beam and the separation-ratio change rate B/G of the blue diffracted beam with respect to the separation-ratio change rate G/G of the green diffracted beam can be suppressed to be within a total of 10% including both positive changes and negative changes.

Thus, according to the second illustrative embodiment, unless the displacement of the pupil center exceeds 2 mm, the extent of changes in the brightness and color balance of the displayed image can be suppressed not to be significant even if the pupil 12 is displaced relative to the exit pupil. Consequently, even though the exit pupil is enlarged by utilizing diffraction, the deterioration in the quality of the displayed image due to the displacement of the pupil 12 can be suppressed.

While some specific embodiments have been described in detail with reference to the drawings, such embodiments are only illustrative. Aspects are practicable in accordance with not only the illustrative embodiment described but also other embodiments, with various modifications and improvements being made thereto on the basis of the knowledge of those skilled in the art.

What is claimed is:

1. A head-mounted display comprising:
a light source (30, 32, 34) configured to emit light having an intensity corresponding to an image signal;
a light scanner (24 (100, 102)) configured to perform two-dimensional scanning with the light emitted from the light source to produce image light;
an emitter (148) configured to emit the image light from the head mounted display;
an optical system having first and second optical elements through which an optical path between the light source and the emitter passes, and
a two-dimensional diffraction grating (160) provided at a position between the first and second optical elements, the diffraction grating having a multistep structure with groove depth changes of at least three discrete levels and configured to enlarge an exit pupil of the head-mounted display.

2. The head-mounted display according to claim 1, wherein the two-dimensional diffraction grating has projections and grooves alternately and periodically provided at a diffraction-grating pitch, the projections and grooves extending both in a first direction and in a second direction intersecting the first direction, and the depth of the grooves changing with at least three levels.

3. The head-mounted display according to claim 2, wherein the two-dimensional diffraction grating is configured such that the second direction orthogonally intersects the first direction.

4. The head-mounted display according to claim 2,
wherein the light source is configured to emit a synthesized beam produced by synthesizing a plurality of component beams having different wavelengths,
wherein the two-dimensional diffraction grating separates the synthesized beam diffracted beams of different orders diffracted in different directions for each of the component beams, the diffracted beams including at least 0th-order, +1st-order, and −1st-order diffracted beams, and
wherein the two-dimensional diffraction grating emits the diffracted beams of different orders in the form of a two-dimensional array at the exit pupil in which the diffracted beams are aligned in the first and second directions.

5. The head-mounted display according to claim 4, wherein design parameters of the two-dimensional diffraction grating that determine the shape of the two-dimensional diffraction grating include a duty ratio and a groove depth, when orders of diffraction in the first and second directions are denoted by x and y, respectively, and a diffracted beam of each order is expressed as an (x, y)th-order diffracted beam, the two-dimensional diffraction grating is configured
such that a ratio of a light intensity of the (x, y)th-order diffracted beam emitted from the two-dimensional diffraction grating to a light intensity of the light applied over the entirety of the two-dimensional diffraction grating is defined as a diffraction efficiency e(x, y) for each of the component beams, and
wherein, for a particular value of the diffraction-grating pitch, the duty ratio and the groove depth are set such that the diffraction efficiency e(x, y) is the same for diffracted beams of orders defined by the same sum of an absolute value of the order of diffraction x and an absolute value of the order of diffraction y.

6. The head-mounted display according to claim 5, wherein, for a particular value of the diffraction-grating pitch, the duty ratio and the groove depth are set, and wherein, letting a and b denote arbitrary orders, the two-dimensional diffraction grating is configured such that the diffraction efficiency e(x, y) is the same for (a, b)th-order, (−a, b)th-order, (a, −b)th-order, and (−a, −b)th-order diffracted beams, and for (a, b)th-order and (b, a)th-order diffracted beams.

7. The head-mounted display according to claim 5, wherein, for a particular value of the diffraction-grating pitch, the duty ratio and the groove depth are set such that the two-dimensional diffraction grating is configured such that all diffraction efficiencies e(x, y) for (0, 0)th-order, (1, 0)th-order, and (1, 1)th-order diffracted beams of each of the component beams are each equal to a predetermined value or within a predetermined range.

8. The head-mounted display according to claim 5, wherein, for a particular value of the diffraction-grating pitch, the duty ratio and the groove depth of the two-dimensional diffraction grating are selected such that the distribution of all diffraction efficiencies e(x, y) for (0, 0)th-order, (1, 0)th-order, and (1, 1)th-order diffracted beams of each of the component beams is minimized.

9. The head-mounted display according to claim 5,
wherein a ratio of a power of an n-th-order diffracted beam to a power of each of the component beams included in the synthesized beam that has entered the two-dimensional diffraction grating is defined as an n-th-order-beam diffraction efficiency, and
wherein, for a particular value of the diffraction-grating pitch, the duty ratio and the groove depth are set such that the longer the wavelengths of the component beams included in the synthesized beam entering the two-dimensional diffraction grating, the higher the lower-order-beam diffraction efficiencies of the two-dimensional diffraction grating including a 0th-order-beam diffraction efficiency.
